(19) United States
(12) Patent Application Publication
(10) Pub. No.: US 2022/0202171 A1
(43) Pub. Date: Jun. 30, 2022

(54) OVER-THE-SHOULDER BAG

(71) Applicant: PETER GIA VU, KENTWOOD, MI (US)

(72) Inventor: PETER GIA VU, KENTWOOD, MI (US)

(21) Appl. No.: 17/534,486

(22) Filed: Nov. 24, 2021

Related U.S. Application Data
(60) Provisional application No. 63/131,152, filed on Dec. 28, 2020.

(51) Int. Cl. A45F 3/02; H04W 4/80

(52) U.S. Cl. CPC A45F 3/02; A45F 2200/0508; H04W 4/80

(57) ABSTRACT

An over-the-shoulder bag that has a portable, multicompartment container assembly with a single, adjustable, L-shaped shoulder strap member, a substantially horizontal jog of the shoulder strap member substantially disposed, when worn by a user, at or below the bottom portion of the container assembly. The container is opened by slidably moving at least one first slider member along a primary flexible strip of metal or plastic with interlocking projections. A water bottle pocket member can hold a water bottle on an outer portion surface of the L-shaped shoulder strap. At least one external pocket member is disposed on an outer surface of the container assembly and in a curved disposition and opened by sliding at least one second tab disposed on at least one secondary flexible strip of metal or plastic with interlocking projections. The inventive concept has at least one USB port and a panic button and speaker assembly.

### CLAIM OF PRIORITY

This application claims priority to and the benefit of U.S. provisional application with Ser. No. 63/131,152, filed on Dec. 28, 2020, with the same title, the contents of which is herein incorporated by reference in its entirety.

### FIELD OF THE INVENTION

The inventive concept relates generally to an over-the-shoulder bag.

### BACKGROUND

Currently, there are a number of solutions for conveniently transporting personal items. One of these solutions attempts to utilize a backpack, but this solution fails to meet the needs of the market because backpacks are optimized to be used with two straps. Another solution attempts to utilize a tote, but this solution is similarly unable to meet the needs of the market because totes can be inconvenient to carry. Still another solution seeks to utilize a purse, but this solution also fails to meet market needs because purses have a limited carrying capacity. Therefore, there currently exists a need in the market for an improved apparatus that holds everyday necessities.

### SUMMARY OF THE INVENTION

The inventive concept is an over-the-shoulder bag for a user that has a portable, multicompartment container assembly with a single, adjustable, L-shaped shoulder strap member coupled at a top end of the shoulder strap member to a top portion of the container assembly and a bottom end of the shoulder strap member to a bottom portion of the container assembly, a substantially horizontal jog of the shoulder strap member substantially disposed, when worn by the user, at or below the bottom portion of the container assembly. The container assembly is designed to be in an open, closed, or partially open state by slidably moving at least one first slider member along a primary flexible strip of metal or plastic with interlocking projections. A water bottle pocket member is designed to hold a water bottle disposed on an outer portion surface of the L-shaped shoulder strap member. At least one external pocket member is disposed on an outer surface of the container assembly and in a curved disposition and designed to be in an open or closed state by sliding at least one second tab member disposed on at least one secondary flexible strip of metal or plastic with interlocking projections. The inventive concept has at least one USB port, and a panic button member coupled to a speaker assembly designed to draw audible attention to the user. One of ordinary skill of the art would recognize that a rechargeable battery would be included to operate the USB port, panic button, and speaker.

In one embodiment of the over-the-shoulder bag, a separate mask pocket member is disposed on the outer surface of the shoulder strap member, the mask pocket member designed to contain a cloth mask member.

In one embodiment of the over-the-shoulder bag, a hook member is coupled to a top surface portion of the top portion of the shoulder strap member designed to hold a flashlight assembly.

In one embodiment of the over-the-shoulder bag, the shoulder strap member has a quick release coupling assembly having a side depressible latch and buckle assembly.

The inventive concept has a pouch at the end of the over-the-shoulder bag member and may have various compartments of different sizes for items such as a wallet, keychain, bandage/emergency package, camera, binoculars, snacks, and other miscellaneous items. In one embodiment of the over-the-shoulder bag member, right above the pouch is the two-compartment meshed holder for coffee/tea thermos and water bottle. Thermos and bottle can be custom-made with extendable straws to drink on the go. Right above this holder, in this embodiment, is a two-compartment holder for an ID badge, notepad, & pen slots while the other meshed compartment is for prescription and sunglasses. The last top holder, in this embodiment, also has two compartments for up to two cellphones, or one cellphone and a walkie-talkie, or a cellphone and listening ear buds. In one embodiment, there are two rope clips on one side and another one on the other side for keys or key chain along the front belt between cellphone holders at one end and a pouch at the end.

It would be advantageous to have an over-the-shoulder bag for a user that is adjustable. Furthermore, it would be advantageous to have an over-the-shoulder bag for a user that is portable. Still further, it would be advantageous to have an over-the-shoulder bag for a user that is retractable.

The inventive concept advantageously fills the aforementioned deficiencies by providing an over-the-shoulder bag, which provides a hands-free, convenient way to carry personal items. In one example embodiment, the bag includes at least one rechargeable, removable module disposed on or in the container assembly, the module including at least one of a near field communication (NFC) module, a GPS module, Bluetooth module or radio frequency module. In another example embodiment, the bag container assembly includes at least one rechargeable, removable power module disposed on or in the container assembly, the power module including at least one of a rechargeable battery, a solar cell or DC/DC converter adapter assembly.

The over-the-shoulder bag for a user is a multi-compartment bag that includes an adjustable shoulder strap. The over-the-shoulder bag for a user may have a retractable identification sleeve. The over-the-shoulder bag for a user fulfills the need for a personal item carrier. Among other things, it is an advantage of the over-the-shoulder bag for a user to provide an over-the-shoulder bag that does not suffer from problems or deficiencies associated with prior solutions.

It is still further an advantage of the over-the-shoulder bag for a user to be durable.

Still further, the over-the-shoulder bag for a user has a shoulder strap flashlight.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates the front of the over-the-shoulder bag for a user.

FIG. 2 illustrates the back of the over-the-shoulder bag for a user.

FIG. 3 illustrates the left side of the over-the-shoulder bag for a user.

FIG. 4 illustrates the right side of the over-the-shoulder bag for a user.

FIG. 5 illustrates the top of the over-the-shoulder bag for a user.

FIG. 6 illustrates the bottom of the over-the-shoulder bag for a user.

FIG. 7 illustrates the front perspective view of the over-the-shoulder bag for a user.

FIG. 8 illustrates the back perspective view of the over-the-shoulder bag for a user.

FIG. 9 illustrates components of the over-the-shoulder bag for a user.

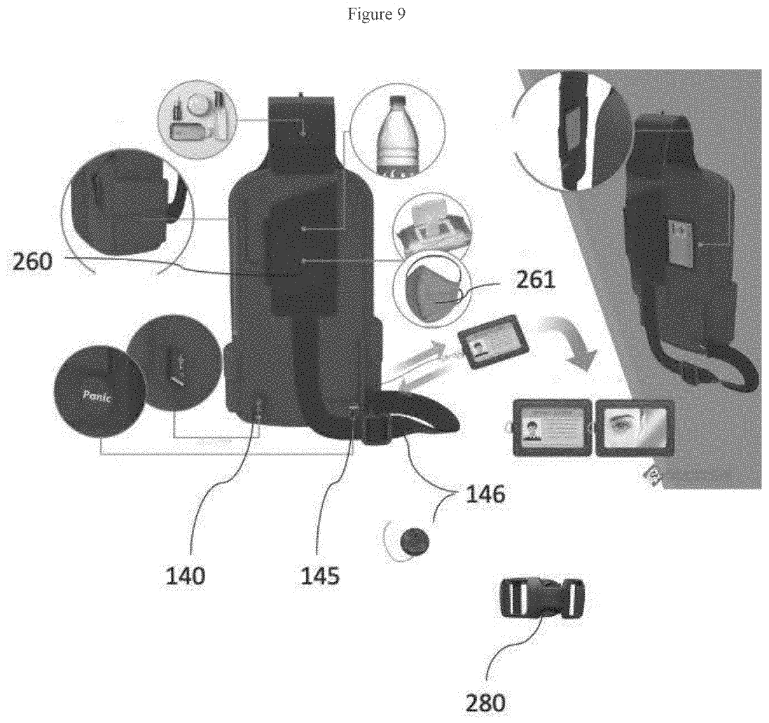

FIG. 10 illustrates components of the top portion of the over-the-shoulder bag for a user.

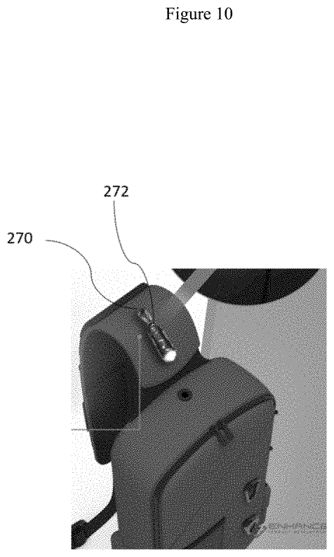

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

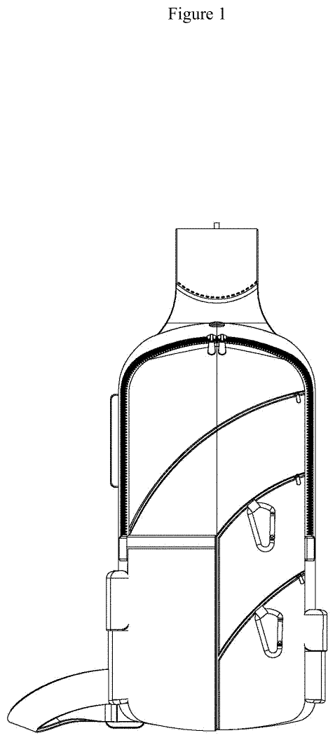

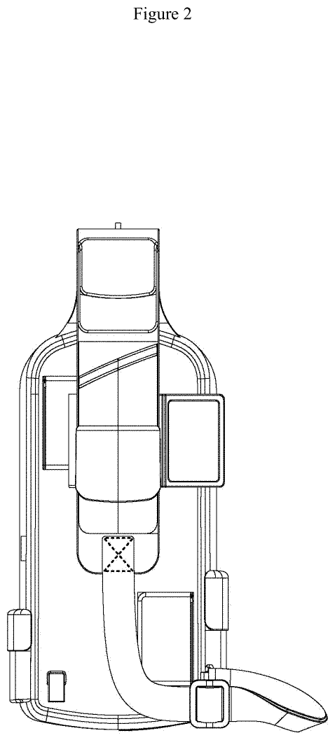

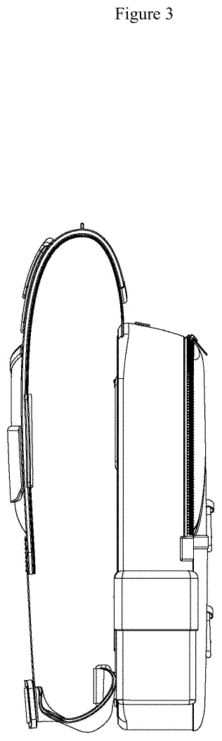

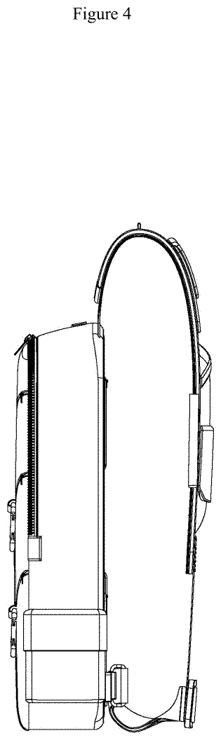

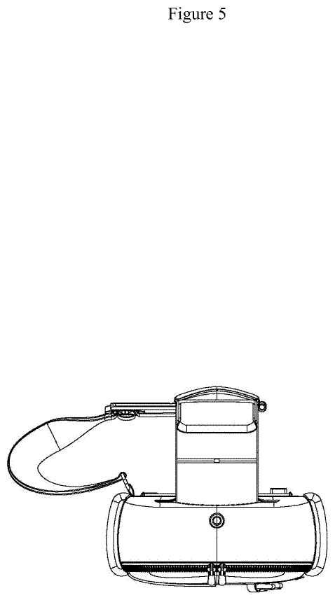

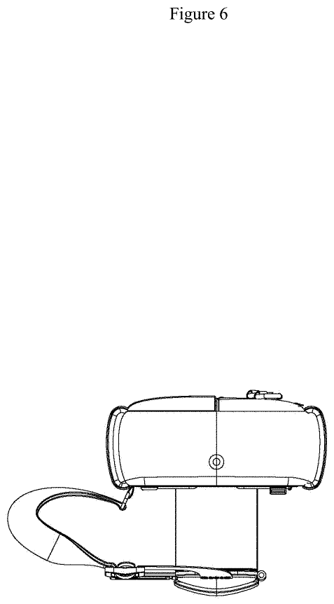

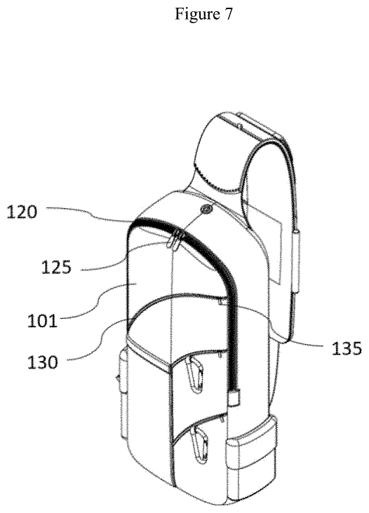

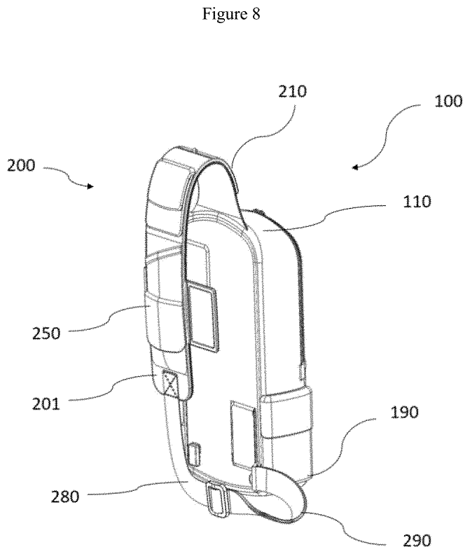

Referring to the figures and the appendix, FIGS. 1-8 illustrate the inventive concept as an over-the-shoulder bag 10 for a user that has a portable, multicompartment container assembly 100 with a single, adjustable, L-shaped shoulder strap member 200 coupled at a top end of the shoulder strap member 210 to a top portion of the container assembly 110 and a bottom end of the shoulder strap member 290 to a bottom portion of the container assembly 190, a substantially horizontal jog of the shoulder strap member 280 substantially disposed, when worn by the user, at or below the bottom portion of the container assembly 190. The container assembly 100 is designed to be in an open, closed, or partially open state by slidably moving at least one first slider member 125 along a primary flexible strip of metal or plastic with interlocking projections 120.

In this example embodiment, a water bottle pocket member 250 is designed to hold a water bottle disposed on an outer portion surface of the L-shaped shoulder strap member 201. At least one external pocket member is disposed on an outer surface of the container assembly 101 and in a curved disposition and designed to be in an open or closed state by sliding at least one second tab member 135 disposed on at least one secondary flexible strip of metal or plastic with interlocking projections 130. The inventive concept has at least one USB port 140 and a panic button member 145 coupled to a speaker assembly 146 designed to draw audible attention to the user.

In one embodiment of the over-the-shoulder bag, a separate mask pocket member 260 is disposed on the outer surface of the shoulder strap 201, the mask pocket member 260 designed to contain a cloth mask member 261.

In one embodiment of the over-the-shoulder bag, a hook member 270 is coupled to a top surface portion of the top portion of the shoulder strap member 202 designed to hold a flashlight assembly 272.

In one embodiment of the over-the-shoulder bag, the shoulder strap member 200 has a quick release coupling assembly having a side depressible latch and buckle assembly 280.

The following patents are incorporated by reference in their entireties: U.S. Pat. Nos. 20130168428A1, D804169, and D811727.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An over-the-shoulder bag for a user comprising:
a portable, multicompartment container assembly with a single, adjustable, L-shaped shoulder strap member coupled at a top end of the shoulder strap member to a top portion of the container assembly and a bottom end of the shoulder strap member to a bottom portion of the container assembly, a substantially horizontal jog of the shoulder strap member substantially disposed, when worn by the user, at or below the bottom portion of the container assembly;
the container assembly adapted to be in an open, closed, or partially open state by slidably moving at least one first slider member along a primary flexible strip of metal or plastic with interlocking projections;
at least one external pocket member disposed on an outer surface of the container assembly and in a curved disposition and adapted to be in an open or closed state by sliding at least one second tab member disposed on at least one secondary flexible strip of metal or plastic with interlocking projections;
at least one USB port; and
a panic button member coupled to a speaker assembly adapted to draw audible attention to the user.

2. The bag of claim 1 further comprising a separate pocket member disposed on the outer surface of the shoulder strap member, the pocket member adapted to contain a mask member or collapsible mouth covering.

3. The bag of claim 1 wherein a hook member is coupled to a top surface portion of the top portion of the shoulder strap member adapted to hold a flashlight assembly.

4. The bag of claim 1 wherein the shoulder strap member has a quick release coupling assembly having a side depressible latch and buckle assembly.

5. The bag of claim 1 further comprising a water bottle pocket member adapted to hold a water bottle disposed on an outer portion surface of the L-shaped shoulder strap member.

6. The bag of claim 1 further comprising at least one rechargeable, removable module disposed on or in the container assembly, the module including at least one of a near field communication (NFC) module, a GPS module, Bluetooth module or radio frequency module.

7. The bag of claim 1 further comprising at least one rechargeable, removable power module disposed on or in the container assembly, the power module including at least one of a rechargeable battery, a solar cell or DC/DC converter adapter assembly.
